(19) United States
(12) Patent Application Publication
(10) Pub. No.: US 2013/0330019 A1
(43) Pub. Date: Dec. 12, 2013

(54) ARRANGEMENT OF IMAGE THUMBNAILS IN SOCIAL IMAGE GALLERY

(71) Applicant: SAMSUNG ELECTRONICS CO., LTD., Suwon (KR)

(72) Inventors: Byoungju Kim, Walnut Creek, CA (US); Prashant Desai, San Francisco, CA (US); Jesse Alvarez, Oakland, CA (US); EunYoung Park, San Francisco, CA (US)

(73) Assignee: Samsung Electronics Co., Ltd.

(21) Appl. No.: 13/912,108

(22) Filed: Jun. 6, 2013

Related U.S. Application Data
(60) Provisional application No. 61/780,702, filed on Mar. 13, 2013.
(60) Provisional application No. 61/657,584, filed on Jun. 8, 2012.

(51) Int. Cl. G06T 3/40

(52) U.S. Cl. CPC G06T 3/4038
USPC 382/298

(57) ABSTRACT

A method of organizing images comprises using an electronic device for selecting image space type for displaying images, sorting one or more images in the selected image space type based on a filter, and sizing the one or more images based on the filter and criteria based on the selected image space type.

### CROSS-REFERENCE TO RELATED APPLICATIONS

This application claims the priority benefit of U.S. Provisional Patent Application Ser. No. 61/657,584, filed Jun. 8, 2012, and U.S. Provisional Patent Application Ser. No. 61/780,702, filed Mar. 13, 2013, both incorporated herein by reference in their entirety.

### TECHNICAL FIELD

An embodiment of the present invention relates generally to displayed photo images, and in particular to organizing photo images based on photo image space type, filtering and sizing, on an electronic device.

### BACKGROUND

With the proliferation of electronic devices such as mobile electronic devices, users use the electronic devices for taking photos. Photos taken on mobile electronic devices, such as cell-phones, can be displayed, but are typically displayed in a single photo space.

### SUMMARY

An embodiment of the present invention relates generally to organizing photo images with an electronic device. One embodiment of the present invention provides organizing photo images based on photo image space type and filtering.

In one embodiment, a method of organizing images comprises using an electronic device for selecting image space type for displaying images, sorting one or more images in the selected image space type based on a filter, and sizing the one or more images based on the filter and criteria based on the selected image space type.

Another embodiment comprises an electronic device. The electronic device comprising a camera, a display and a mobile image gallery module. The mobile image gallery module provides for sorting and sizing images based on a filter and image space type. Image space type comprises one of personal space and social space types.

One embodiment comprises a computer program product for sorting and sizing images. The computer program product comprising a tangible storage medium readable by a computer system and storing instructions for execution by the computer system for performing a method. The method comprising using an electronic device for selecting an image space type for displaying images. One or more images in the selected image space type is sorted based on a filter. The one or more images is sized based on the filter and criteria based on the selected image space type.

Another embodiment comprises a graphical user interface (GUI) displayed on a display of an electronic device. The GUI comprising a selectable image space, and a plurality of images that are ordered and sized within the selectable image space based on customizable filtering criteria.

These and other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIGS. 1A-1B show block diagrams of architecture on a system for organizing photos with an electronic device, according to an embodiment of the invention.

FIG. 2 shows an example of organized images, according to an embodiment of the invention.

FIGS. 3A-B show examples of changing image space type, according to an embodiment of the invention.

FIGS. 4A-C show examples of personal photo image space type interaction, according to an embodiment of the invention.

FIG. 5 shows an example of a thumbnail structure for a personal photo image space type, according to an embodiment of the invention.

FIGS. 6A-C show examples of social photo image space type interaction, according to an embodiment of the invention.

FIG. 7 shows an example of a thumbnail structure for a social photo image space type, according to an embodiment of the invention.

FIG. 8 shows a flowchart of a process for organizing photos, according to an embodiment of the invention.

FIG. 9 is a high-level block diagram showing an information processing system comprising a computing system implementing an embodiment of the present invention.

FIG. 10 shows a computing environment for implementing an embodiment.

FIG. 11 shows a computing environment for implementing an embodiment.

FIG. 12 shows a computing environment for organizing photo images, according to an embodiment.

FIG. 13 shows a block diagram of an architecture for a local endpoint host, according to an example embodiment.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

An embodiment of the present invention relates generally to using an electronic device for organizing photos in a gallery. In one embodiment the present invention provides organizing photos in display order and display size based on photo image space type and personalized criteria.

In one embodiment, the electronic device comprises a mobile electronic device capable of data communication over a communication link such as a wireless communication link. Examples of such mobile device include a mobile phone device, a mobile tablet device, smart mobile devices, etc.

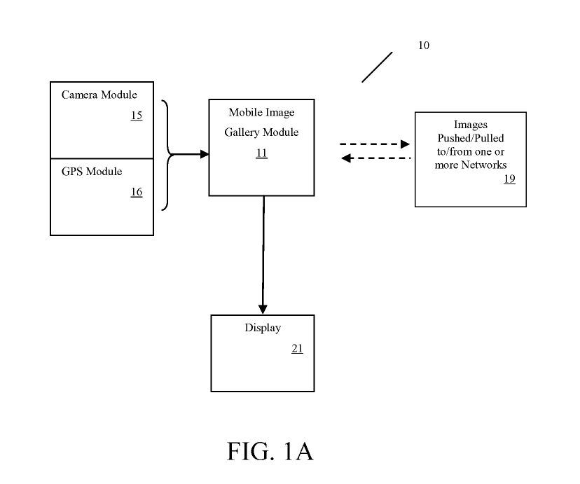

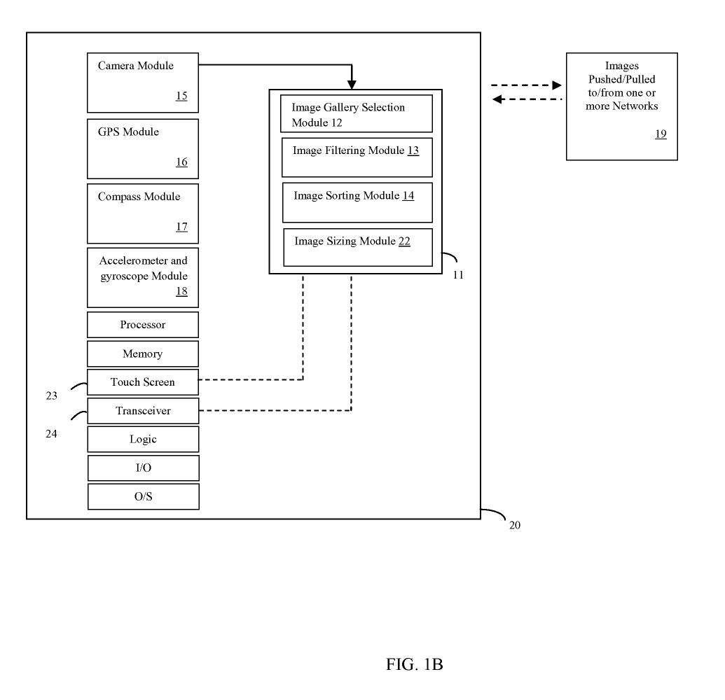

FIG. 1A shows a functional block diagram of an embodiment of a photo gallery organization system 10 for organizing photo images with an electronic device (such as mobile device 20 as shown in FIG. 1B), according to an embodiment of the invention.

The system 10 comprises a mobile image gallery module 11 including an image gallery selection module 12 (FIG. 1B), an image filtering module 13 (FIG. 1B), an image sorting module 14 (FIG. 1B) and an image sizing module 22 (FIG. 1B). The mobile image gallery module 11 utilizes mobile device hardware functionality including one or more of: camera module 15, global positioning satellite (GPS) receiver module 16, compass module 17, and accelerometer and gyroscope module 18.

The camera module 15 is used to capture images of objects, such as people, surroundings, places, etc. Ion one embodiment, photo images 19 may also be pushed/pulled from one or more networks (e.g., cloud networks, social networks, etc.). The GPS module 16 is used to identify a current location of the mobile device 20 (i.e., user). The compass module 17 is used to identify direction of the mobile device. The accelerometer and gyroscope module 18 is used to identify tilt of the mobile device.

The system 10 provides selection of photo image space type (e.g., personal space photos or social space photos) and organizational display of photos with respect to order and thumbnail sizing based on defaults criteria or selected filtering on the display 21 of the mobile device 20. The system 10 provides a simple, fluid, and responsive user experience.

The organization of photo images/photo albums on a display 21 of a mobile device 20 comprises determining information for sizing of thumbnail display size and photo image ordering/sorting based on filtering criteria (e.g., alphabetical, time, people names, location, tags, etc.) and photo image space type. For example, Google Android mobile operating system application programming interface (API) components providing such information may be employed.

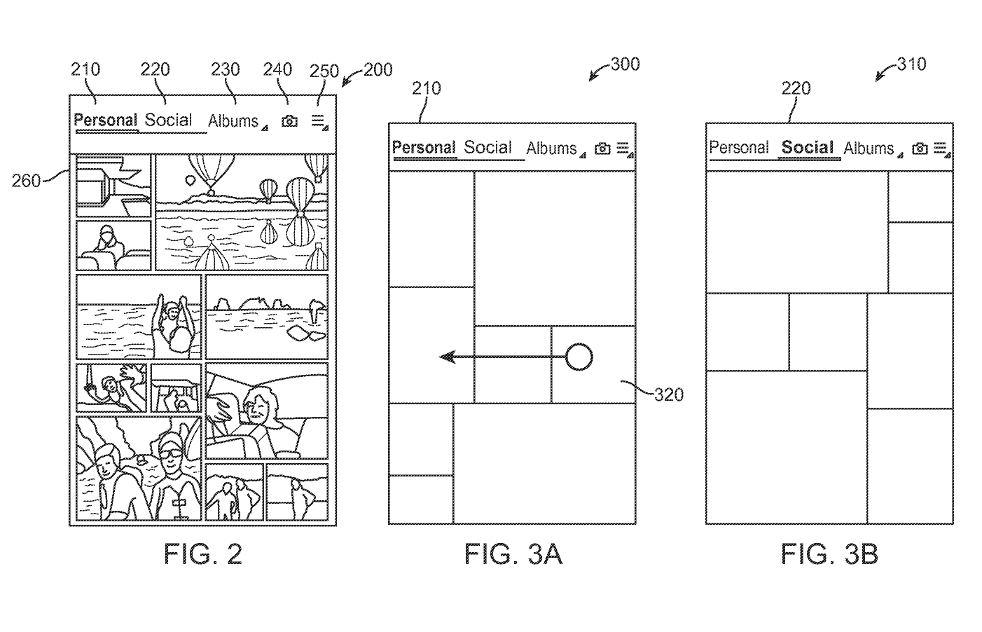

FIG. 2 shows an example gallery display page format 200 according to one embodiment of the invention. In one embodiment, the gallery display page format 200 includes a personal space tab 210, social space tab 220, filter options tab 230, camera tab 240, options tab 250 and photos/albums image s display section 260 for displaying various sized photo images. In one example, the personal space tab 210, the social space tab 220, the filter options tab 230, the camera tab 240, and the options tab 250 may be selected by touching/pressing the space indicated by the tabs using the touch screen 23. In other embodiments, the personal space tab 210, the social space tab 220, the filter options tab 230, the camera tab 240, and the options tab 250 may be selected by other means, such as voice recognition.

In one embodiment, the personal space tab 210 provides for selection of personal space photos and albums using the image gallery selection module 12. In one example, the personal space photos and albums comprise photos and albums that are personal to a user, for example, personally taken photos, personally shared photos, etc. In one embodiment, the social space tab 220 provides for selection of social space photos and albums. In one example, the social space photos and albums comprise photos and albums that are provided to/from a social network platform or website and is either downloaded/pulled to the mobile device 20 or shared from a social platform (e.g., via a link).

FIGS. 3A-B show switching from personal photo image space type based on a finger swipe applied to the screen of the mobile device 20 according to one embodiment of the invention. In FIG. 3A, the screen is touched and swiped with a right to left finger motion. This right to left finger motion applied when the social tab 220 has been selected on the display 310 then changes to having the personal tab 310 selected on the display 300.

In one embodiment, the filters option tab 230 allows for selection of a desired filter based on selected photo image space type for organizing/sorting photos/albums based on the selected filter using the image filtering module 13. In one example, the filters provide for organizing/sorting photos/albums in title alphabetical order, chronological order, people name alphabetical order, location based order, ordered based on applied tags, etc. using the image sorting module 14. In one embodiment, sizing arrangement of thumbnails is based on the selected filter and selected photo image space type.

Personal photo image space type ordering/sorting and sizing.

For personal photo image space type, the ordering/sorting filters comprise album, time, people, location and tags. In one embodiment, album filtering comprises ordering/sorting photos/albums based on photo/album storage location, e.g., photos/albums stored in local memory on the mobile device 20, stored on a cloud environment, stored on a network, stored in external media, etc. The sizing arrangement of thumbnails for size organization associated with the album filtering is based on number of times each album has been accessed.

In one embodiment, time filtering comprises ordering/sorting photos/albums based on a timestamp associated with the album/photo. The sizing arrangement of thumbnails for size organization associated with the time filtering is based on number of times each album has been accessed. In one embodiment, people filtering comprises ordering/sorting photos/albums based on alphabetical order of people names associated with the album/photo. The sizing arrangement of thumbnails for size organization associated with the people filtering is based on number of times each album has been accessed.

In one embodiment, location filtering comprises ordering/sorting photos/albums based on where a photo/album was created as compared to a current location of the mobile device 20. In one embodiment, each photo includes a geo-tag that includes location information supplied by the GPS module 16. The difference between locations is determined and used to sort/order the photos. The sizing arrangement of thumbnails for size organization associated with the location filtering is based on number of times each album has been accessed. In one embodiment, tags filtering comprises ordering/sorting photos/albums based on alphabetical order of tags associated with the album/photo. The sizing arrangement of thumbnails for size organization associated with the people filtering is based on number of times each album has been accessed.

In one embodiment, a default filter is applied prior to a user selected filter. A default filter may comprise organizing a photo gallery based on ordering/sorting photos/albums based on the selected photo image space type (i.e., personal photo image space type or social photo image space type). In one embodiment, when the personal photo image space type is selected via the personal space tab 210, the default ordering/sorting of photos may be set to display albums sorted in distance (from the top of the display as a user scrolls vertically) by the image sorting module 14 from most local storage location (e.g., memory on the mobile device 20) to the furthest storage location of photo albums (e.g., memory of a cloud environment). In one embodiment, for the default photo sizing organization in the personal photo image space type, the image sizing module 22 sizes the thumbnails based on the number of times an album has been accessed. In one embodiment, the mobile image gallery module 11 dynamically accesses user logs to determine number of accesses and photo information for determining storage locations.

Social photo image space type ordering/sorting and sizing.

For social photo image space type, the ordering/sorting filters comprise time, location, people, popularity and recent activity. In one embodiment, time filtering comprises ordering/sorting photos/albums based on a timestamp associated with the album/photo. The sizing arrangement of thumbnails for size organization associated with the time filtering is based on number of times each album has been accessed. In one embodiment, location filtering comprises ordering/sorting photos/albums based on where a photo/album was created as compared to a current location of the mobile device 20. In one embodiment, each photo includes a geo-tag that includes location information supplied by the GPS module 16. The difference between locations is determined and used to sort/order the photos. The sizing arrangement of thumbnails for size organization associated with the location filtering is based on number of times each album has been accessed. In one embodiment, if two or more photos have a same number of accesses, than sizing of these photos is based on social activity. For example, photos associated with more “likes,” comments, etc. are presented higher in a display from top to bottom.

In one embodiment, people filtering comprises ordering/sorting photos/albums based on alphabetical order of people names associated with the album/photo (e.g., photo owner, service providing the photo, etc.). The sizing arrangement of thumbnails for size organization associated with the people filtering is based on number of times each album has been accessed. The sizing arrangement of thumbnails for size organization associated with the people filtering is based on number of times each album has been accessed (e.g., number of accesses into the album). In one embodiment, if two or more photos have a same number of accesses, than sizing of these photos is based on social activity. For example, photos associated with more “likes,” comments, etc. are presented higher in a display from top to bottom.

In one embodiment, popularity filtering comprises ordering/sorting photos/albums based on number of “likes,” views, comments, re-tweets, blogging, re-blogging, Instagram® votes, etc. associated with the album/photo. The sizing arrangement of thumbnails for size organization associated with the popularity filtering is also based on popularity. In one embodiment, recent activity filtering comprises ordering/sorting photos/albums based on number recent social activity that has occurred (e.g., recent “like,” view, comment, re-tweet, blog, re-blog, Instagram® vote, etc.) associated with the album/photo. The sizing arrangement of thumbnails for size organization associated with the recent activity filtering is based on a most recent posting/liking, etc. based on time.

In one embodiment, when the social photo image space type is selected via the social space tab 220, the default ordering/sorting of photos may be set by the image sorting module 14 to display people sorted from the top of the display (as a user scrolls vertically) based on social connections that a user has most frequently or recently communicated (e.g., active social interaction). In one embodiment, for the default photo sizing organization in the social photo image space type, the image sizing module 22 sizes the thumbnails based on the same criteria (i.e., active social interaction) as the default ordering/sorting.

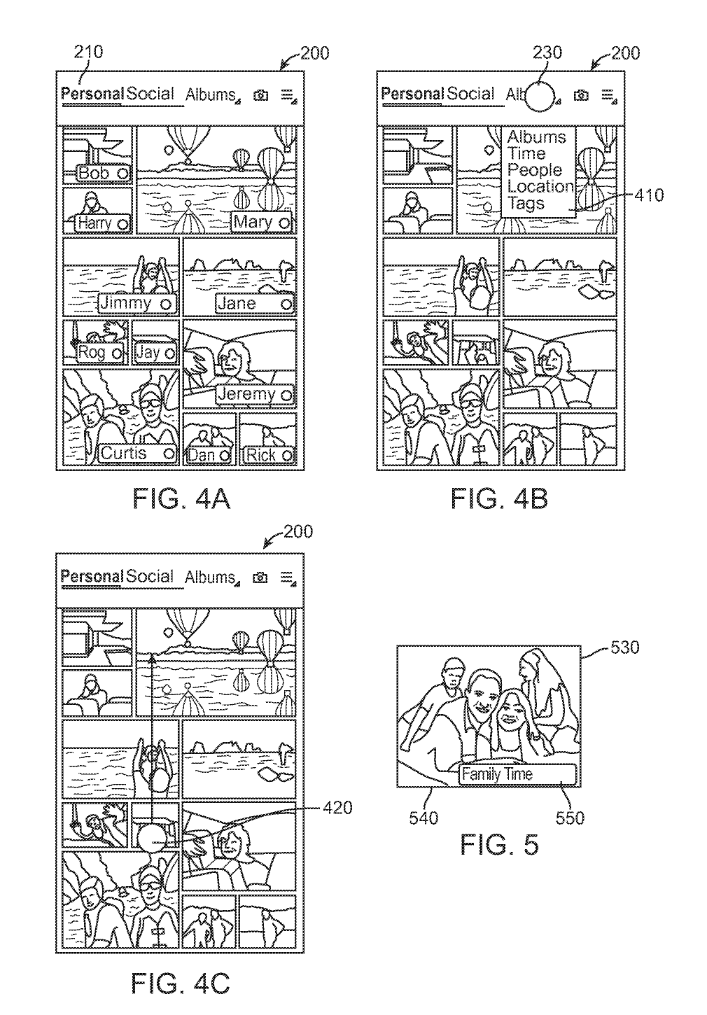

FIGS. 4A-C illustrate a series of displays on the mobile device 20 for accessing the personal photo image space type. FIG. 4A shows display screen 200 with the personal tab 210 selected showing example photos in sorted order and sized based on a selected or default filter. FIG. 4B shows the display screen 200 with the filter tab 230 being pressed to show a drop-down menu of available filters 410. FIG. 4C illustrates display 200 where a finger swipe 420 in the upward direction of the display screen 200 shows more photos in the personal gallery.

FIG. 5 illustrates a thumbnail structure 530 for a thumbnail displayed in the personal gallery based on accessing the personal photo image space type with the personal tab 210. The thumbnail structure 530 may include the album/author name 540 and source 550 (e.g., location of storage, where or who the photo was obtained from, etc.).

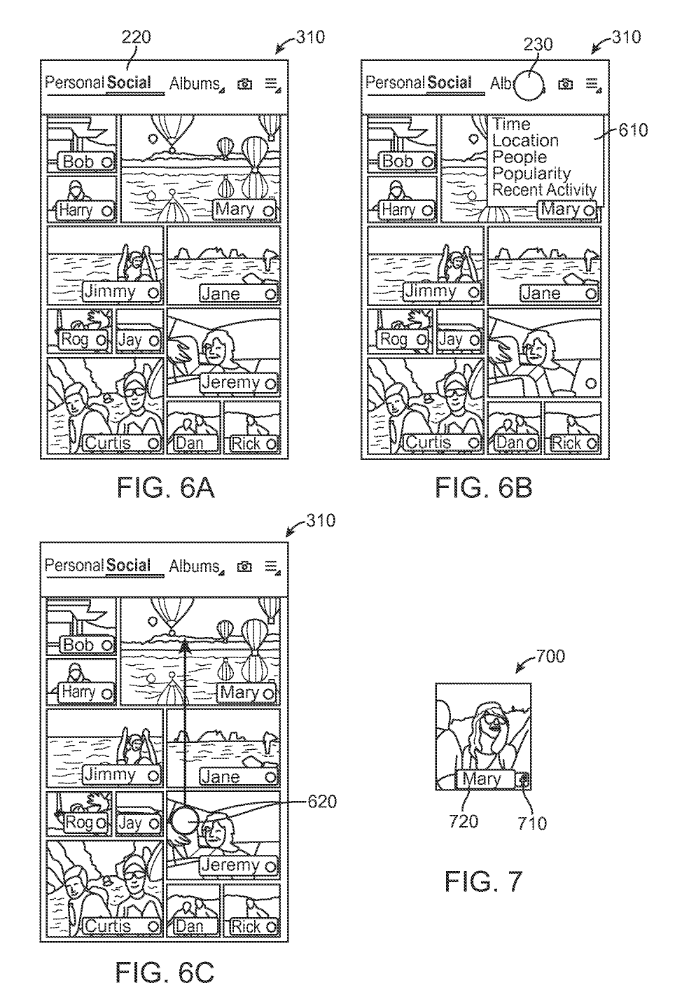

FIGS. 6A-C illustrate a series of displays on the mobile device 20 for accessing the social photo image space type. FIG. 6A shows display screen 310 with the personal tab 220 selected showing example photos in sorted order and sized based on a selected or default filter. FIG. 6B shows the display screen 310 with the filter tab 230 being pressed to show a drop-down menu of available filters 610. FIG. 6C illustrates display 310 where a finger swipe 620 in the upward direction of the display screen 310 shows more photos in the social gallery.

FIG. 7 illustrates a thumbnail structure 700 for a thumbnail displayed in the social gallery based on accessing the social photo image space type with the personal tab 210. The thumbnail structure 700 may include the album/author name 720 and source 710 (e.g., social platform symbol, name, etc.).

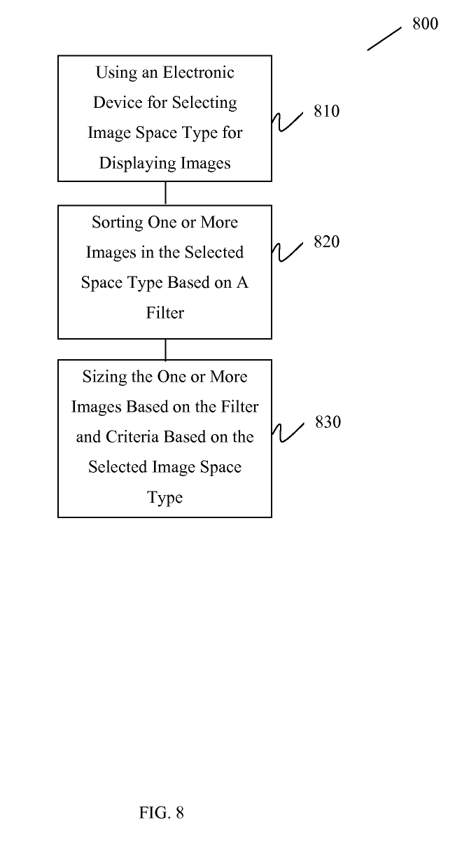

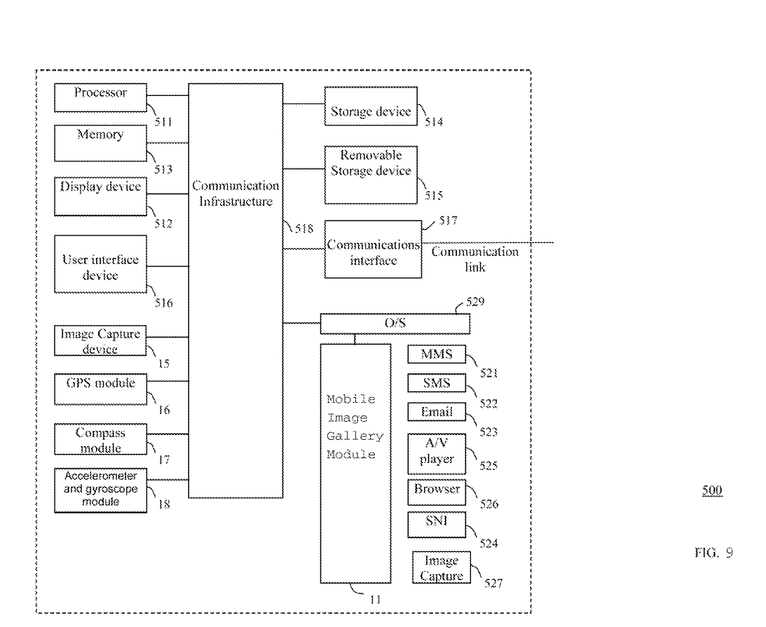

FIG. 8 shows a flowchart of a process 800 for organizing photos depending on a gallery selected (e.g., personal photo image space type or social photo image space type), according to an embodiment of the invention. Process block 810 comprises using an electronic device for selecting photo image space type for displaying images on a display, such as display 21. Process block 820 comprises sorting photo images in the selected space type based on a filter. Process block 830 comprises sizing the photo images based on the filter and criteria based on the selected photo image space type.

FIG. 9 is a high-level block diagram showing an information processing system comprising a computing system 500 implementing an embodiment of the present invention. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as WiFi, Cellular), a network interface (such as an Ethernet card), a communications port, or a PCMCIA slot and card). The communication interface 517 allows software and data to be transferred between the computer system and external devices. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

In one implementation of the invention in a mobile wireless device such as a mobile phone, the system 500 further includes an image capture device such as a camera 15. The system 500 may further include application modules as MMS module 521, SMS module 522, email module 523, social network interface (SNI) module 524, audio/video (AV) player 525, web browser 526, image capture module 527, etc.

The system 500 further includes a mobile image gallery module 11 as described herein, according to an embodiment of the invention. In one implementation of said mobile image gallery module 11 along an operating system 529 may be implemented as executable code residing in a memory of the system 500. In another embodiment, such modules are in firmware, etc.

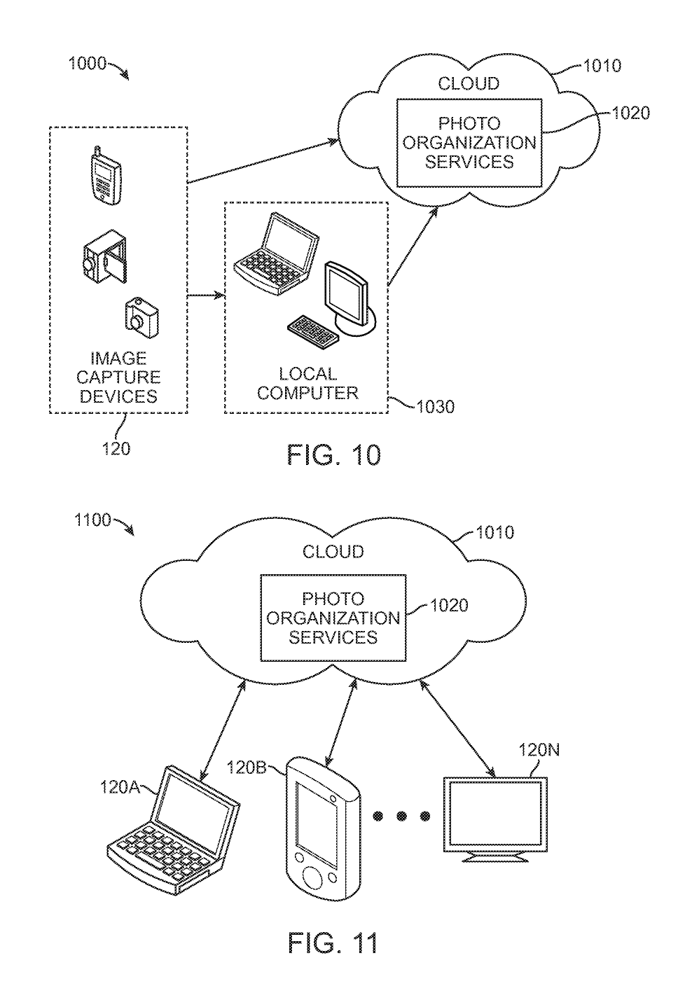

FIGS. 10 and 11 illustrate examples of networking environments 1000 and 1100 for cloud computing in which photo organization embodiments described herein may utilize. In one embodiment, in the environment 1000, the cloud 1010 provides services 1020 (such as photo organization, social networking services, among other examples) for user computing devices, such as an electronic device 20 or electronic device 120 (e.g., mobile cell phone, tablet device, camera, wearable device, laptop computer, etc.). In one embodiment, services may be provided in the cloud 1010 through cloud computing service providers, or through other providers of online services. In one example embodiment, the cloud-based services 1020 may include photo organization services that uses any of the techniques disclosed, a media storage service, a social networking site, or other services via which media (e.g., from user sources) are stored and distributed to connected devices.

In one embodiment, various electronic devices 120 include image or video capture devices to capture one or more images or video, create or share comments, organize media, etc. In one embodiment, the electronic devices 120 may upload one or more digital images to the service 1020 on the cloud 1010 either directly (e.g., using a data transmission service of a telecommunications network) or by first transferring the one or more images to a local computer 1030, such as a personal computer, mobile device, wearable device, or other network computing device.

In one embodiment, as shown in environment 1100 in FIG. 11, cloud 1010 may also be used to provide services that include photo organization embodiments to connected electronic devices 120A-120N that have a variety of screen display sizes. In one embodiment, electronic device 120A represents a device with a mid-size display screen, such as what may be available on a personal computer, a laptop, or other like network-connected device. In one embodiment, electronic device 120B represents a device with a display screen configured to be highly portable (e.g., a small size screen). In one example embodiment, electronic device 120B may be a smartphone, PDA, tablet computer, portable entertainment system, media player, wearable device, or the like. In one embodiment, electronic device 120N represents a connected device with a large viewing screen. In one example embodiment, electronic device 120N may be a television screen (e.g., a smart television) or another device that provides image output to a television or an image projector (e.g., a set-top box or gaming console), or other devices with like image display output. In one embodiment, the electronic devices 120A-120N may further include image capturing hardware. In one example embodiment, the electronic device 120B may be a mobile device with one or more image sensors, and the electronic device 120N may be a television coupled to an entertainment console having an accessory that includes one or more image sensors.

In one or more embodiments, in the cloud-computing network environments 1000 and 1100, any of the embodiments may be implemented at least in part by cloud 1010. In one embodiment example, photo organization techniques are implemented in software on the local computer 1030, one of the electronic devices 120, and/or electronic devices 120A-N. In another example embodiment, the photo organization techniques are implemented in the cloud and applied to comments and media as they are uploaded to and stored in the cloud. In this scenario, the photo organization embodiments may be performed using media stored in the cloud as well.

In one or more embodiments, media is shared across one or more social platforms from an electronic device 120. Typically, the shared media is only available to a user if the friend or family member shares it with the user by manually sending the media (e.g., via a multimedia messaging service (“MMS”)) or granting permission to access from a social network platform. Once the media is created and viewed, people typically enjoy sharing them with their friends and family, and sometimes the entire world. Viewers of the media will often want to add metadata or their own thoughts and feelings about the media using paradigms like comments, “likes,” and tags of people. Traditionally, this type of supplemental social data is made via separate social media platforms or applications (e.g., apps).

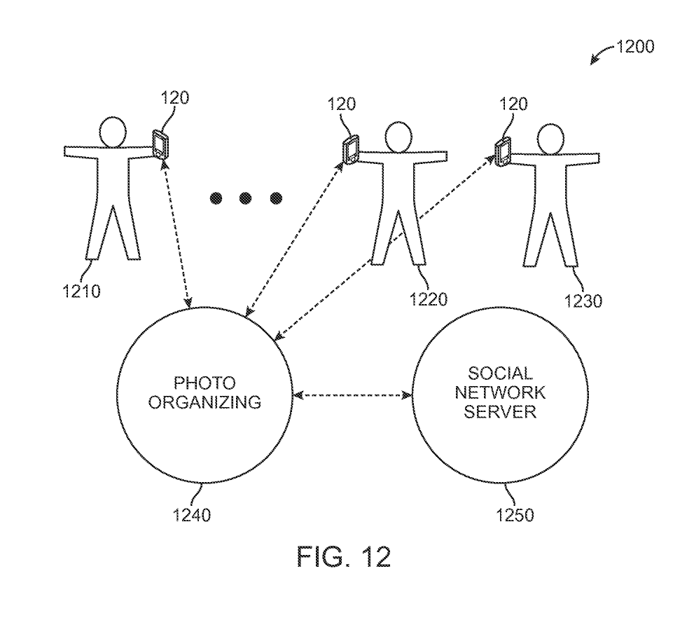

FIG. 12 is a block diagram 1200 illustrating example users of a photo organization system according to an embodiment. In one embodiment, users 1210, 1220, 1230 are shown, each having a respective electronic device 120 that is capable of capturing digital media (e.g., images, video, audio, or other such media) and providing photo organization. In one embodiment, the electronic devices 120 are configured to communicate with a photo organization controller 1240, which is may be a remotely-located server, but may also be a controller implemented locally by one of the electronic devices 120. In one embodiment where the photo organization controller 1240 is a remotely-located server, the server may be accessed using the wireless modem, communication network associated with the electronic device 120, etc. In one embodiment, the photo organization controller 1240 is configured for two-way communication with the electronic devices 120. In one embodiment, the photo organization controller 1240 is configured to communicate with and access data from one or more social network servers 1250 (e.g., over a public network, such as the Internet).

In one embodiment, the social network servers 1250 may be servers operated by any of a wide variety of social network providers (e.g., Facebook®, Instagram®, Flickr®, and the like) and generally comprise servers that store information about users that are connected to one another by one or more interdependencies (e.g., friends, business relationship, family, and the like). Although some of the user information stored by a social network server is private, some portion of user information is typically public information (e.g., a basic profile of the user that includes a user's name, picture, and general information). Additionally, in some instances, a user's private information may be accessed by using the user's login and password information. The information available from a user's social network account may be expansive and may include one or more lists of friends, current location information (e.g., whether the user has “checked in” to a particular locale), additional images of the user or the user's friends. Further, the available information may include additional information (e.g., metatags in user photos indicating the identity of people in the photo or geographical data. Depending on the privacy setting established by the user, at least some of this information may be available publicly. In one embodiment, a user that desires to allow access to his or her social network account for purposes of aiding the photo organization controller 1240 may provide login and password information through an appropriate settings screen. In one embodiment, this information may then be stored by the photo organization controller 1240. In one embodiment, a user's private or public social network information may be searched and accessed by communicating with the social network server 1250, using an application programming interface (“API”) provided by the social network operator.

In one embodiment, the photo organization controller 1240 performs operations associated with a media sharing application or method. In one example embodiment, the photo organization controller 1240 may receive media from a plurality of users (or just from the local user), determine relationships between two or more of the users (e.g., according to user-selected criteria), and transmit comments and/or media to one or more users based on the determined relationships.

In one embodiment, the photo organization controller 1240 need not be implemented by a remote server, as any one or more of the operations performed by the photo organization controller 1240 may be performed locally by any of the electronic devices 120, or in another distributed computing environment (e.g., a cloud computing environment). In one embodiment, the sharing of media may be performed locally at the electronic device 120.

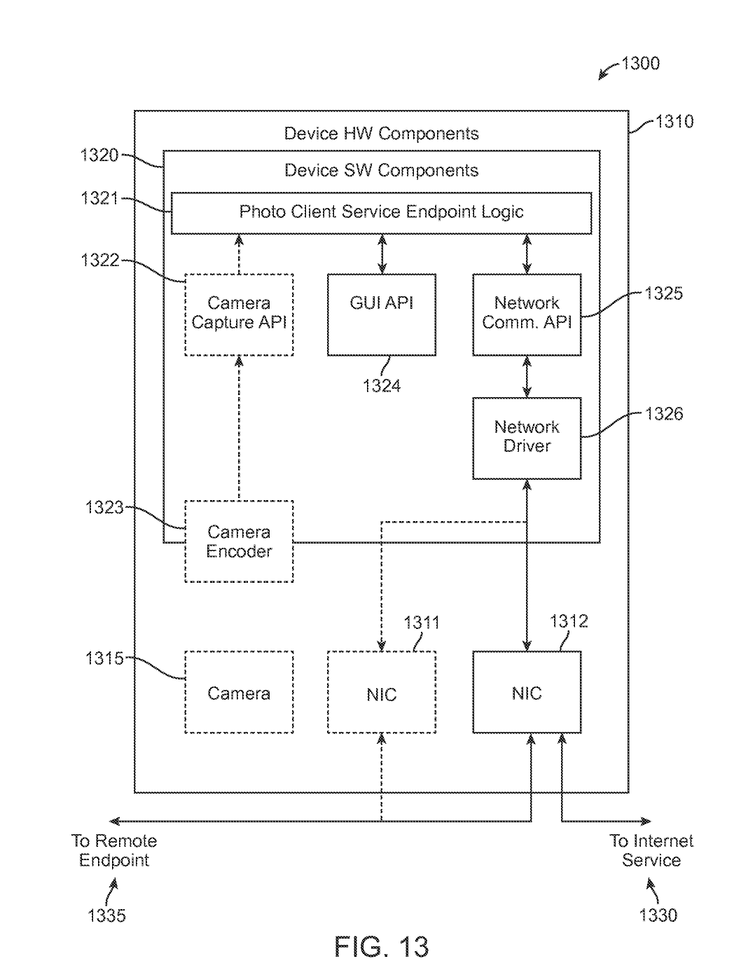

FIG. 13 shows an architecture for a local endpoint host 1300, according to an embodiment. In one embodiment, the local endpoint host 1300 comprises a hardware (HW) portion 1310 and a software (SW) portion 1320. In one embodiment, the HW portion 1310 comprises the camera 1315, network interface (NIC) 1311 (optional) and NIC 1312 and a portion of the camera encoder 1323 (optional). In one embodiment, the SW portion 1320 comprises photo client service endpoint logic 1321, camera capture API 1322 (optional), a graphical user interface (GUI) API 1324, network communication API 1325, and network driver 1326. In one embodiment, the content flow (e.g., text, graphics, photo, video and/or audio content, and/or reference content (e.g., a link)) flows to the remote endpoint in the direction of the flow 1335, and communication of external links, graphic, photo, text, video and/or audio sources, etc. flow to a network service (e.g., Internet service) in the direction of flow 1330.

One or more embodiments, use features of WebRTC for acquiring and communicating streaming data. In one embodiment, the use of WebRTC implements one or more of the following APIs: MediaStream (e.g., to get access to data streams, such as from the user's camera and microphone), RTCPeerConnection (e.g., audio or video calling, with facilities for encryption and bandwidth management), RTCDataChannel (e.g., for peer-to-peer communication of generic data), etc.

In one embodiment, the MediaStream API represents synchronized streams of media. For example, a stream taken from camera and microphone input may have synchronized video and audio tracks. One or more embodiments may implement an RTCPeerConnection API to communicate streaming data between browsers (e.g., peers), but also use signaling (e.g., messaging protocol, such as SIP or XMPP, and any appropriate duplex (two-way) communication channel) to coordinate communication and to send control messages. In one embodiment, signaling is used to exchange three types of information: session control messages (e.g., to initialize or close communication and report errors), network configuration (e.g., a computer's IP address and port information), and media capabilities (e.g., what codecs and resolutions may be handled by the browser and the browser it wants to communicate with).

In one embodiment, the RTCPeerConnection API is the WebRTC component that handles stable and efficient communication of streaming data between peers. In one embodiment, an implementation establishes a channel for communication using an API, such as by the following processes: client A generates a unique ID, Client A requests a Channel token from the App Engine app, passing its ID, App Engine app requests a channel and a token for the client's ID from the Channel API, App sends the token to Client A, Client A opens a socket and listens on the channel set up on the server. In one embodiment, an implementation sends a message by the following processes: Client B makes a POST request to the App Engine app with an update, the App Engine app passes a request to the channel, the channel carries a message to Client A, and Client A's onmessage callback is called.

In one embodiment, WebRTC may be implemented for a one-to-one communication, or with multiple peers each communicating with each other directly, peer-to-peer, or via a centralized server. In one embodiment, Gateway servers may enable a WebRTC app running on a browser to interact with electronic devices.

In one embodiment, the RTCDataChannel API is implemented to enable peer-to-peer exchange of arbitrary data, with low latency and high throughput. In one or more embodiments, WebRTC may be used for leveraging of RTCPeerConnection API session setup, multiple simultaneous channels, with prioritization, reliable and unreliable delivery semantics, built-in security (DTLS), and congestion control, and ability to use with or without audio or video.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

Embodiments of the present invention have been described with reference to flowchart illustrations and/or block diagrams of methods, apparatus (systems) and computer program products according to embodiments of the invention. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments of the present invention. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of the invention.

Though the present invention has been described with reference to certain versions thereof; however, other versions are possible. Therefore, the spirit and scope of the appended claims should not be limited to the description of the preferred versions contained herein.

What is claimed is:

1. A method of organizing images comprising:
using an electronic device for selecting image space type for displaying images;
sorting one or more images in the selected image space type based on a filter; and
sizing the one or more images based on the filter and criteria based on the selected image space type.

2. The method of claim 1, wherein the image space type comprises one of personal space and social space types.

3. The method of claim 2, wherein personal space type images comprise personal or private images stored on the electronic device or stored in a networked cloud space.

4. The method of claim 3, wherein social space type images comprise images shared between mobile devices or obtained through social network platforms.

5. The method of claim 1, further comprising:
selecting a filter type for selective sorting the one or more images in the selected image space type.

6. The method of claim 2, wherein filter types for personal space images comprise album, time, people, location, tags and recent activity.

7. The method of claim 6, wherein filter types for social space images comprise popularity, time, people, location and recent activity.

8. The method of claim 7, wherein sizing the one or more images comprises sizing thumbnail images based on selected filter type and one or more levels of criteria based on image space type.

9. The method of claim 8, wherein the criteria for personal image space type comprises image access frequency.

10. The method of claim 8, wherein the criteria for social image space type comprises social interaction involving the images.

11. The method of claim 8, wherein each thumbnail image comprises a display structure including an assigned name and image source.

12. The method of claim 1, wherein the one or more images are dynamically sorted and sized.

13. The method of claim 1, wherein the electronic device comprises a mobile electronic device.

14. The method of claim 11, wherein the mobile electronic device comprises one of a mobile phone, a tablet device, and a mobile computing device.

15. An electronic device, comprising:
a camera;
a display; and
a mobile image gallery module that provides for sorting and sizing images based on a filter and image space type;
wherein image space type comprises one of personal space and social space types.

16. The electronic device of claim 15, wherein personal space type images comprise personal or private images stored on the electronic device or maintained in a networked cloud space, and wherein social space type images comprise images shared between mobile devices or obtained through social network platforms.

17. The electronic device of claim 16, wherein the filter for personal space images comprises one of album, time, people, location, tags or recent activity, and wherein the filter for social space images comprises one of popularity, time, people, location or recent activity.

18. The electronic device of claim 17, wherein sizing the one or more images comprises sizing thumbnail images based on the filter and one or more levels of criteria based on image space type, and wherein the criteria for personal image space type comprises image access frequency, and the criteria for social image space type comprises social interaction involving the images.

19. The electronic device of claim 15, wherein the mobile image gallery module dynamically sorts and sizes the images.

20. A computer program product for sorting and sizing images, the computer program product comprising:
a tangible storage medium readable by a computer system and storing instructions for execution by the computer system for performing a method comprising:
using an electronic device for selecting an image space type for displaying images;
sorting one or more images in the selected image space type based on a filter; and
sizing the one or more images based on the filter and criteria based on the selected image space type.

21. The computer program product of claim 20, wherein the image space type comprises one of personal space and social space types, and wherein personal space type images comprise personal or private images stored on a mobile device or stored in a networked cloud space, and social space type images comprise images shared between mobile devices or obtained through social network platforms.

22. The computer program product of claim 21, further comprising:
selecting a filter type for selective sorting the one or more images in the selected image space type, wherein filter types for personal space images comprise album, time, people, location, tags and recent activity, and filter types for social space images comprise popularity, time, people, location and recent activity.

23. The computer program product of claim 22, wherein sizing the one or more images comprises sizing thumbnail images based on selected filter type and one or more levels of criteria based on image space type.

24. The computer program product of claim 23, wherein the criteria for personal image space type comprises image access frequency, and the criteria for social image space type comprises social interaction involving the images.

25. The computer program product of claim 24, wherein the images are dynamically sorted and sized.

26. A graphical user interface (GUI) displayed on a display of an electronic device, comprising:
a selectable image space; and
a plurality of images that are ordered and sized within the selectable image space based on customizable filtering criteria.

27. The GUI of claim 26, wherein the selectable image space is selectable based on one of a selectable tab, and a directional swipe on the image space on the GUI, and wherein the image space is separated into a personal image space and a social media image space.

28. The GUI of claim 27, wherein the filtering criteria for the personal image space comprise one or more of album, time, people, location, tags and recent activity, and the filtering criteria for the social image space comprise one or more of popularity, time, people, location and recent activity.

29. The GUI of claim 28, wherein sizing the plurality of images comprises sizing thumbnail images displayed on the GUI based on selected filter criteria and one or more levels of additional criteria based on image space type.

30. The GUI of claim 29, wherein the additional criteria for the personal image space comprises image access frequency, and the additional criteria for the social image space comprises social interaction involving the plurality of images, and wherein each thumbnail image comprises a display structure including an assigned name and image source.
